(19) United States
(12) Patent Application Publication
(10) Pub. No.: US 2012/0195600 A1
(43) Pub. Date: Aug. 2, 2012

(54) REFERENCE-SIGNAL DISTRIBUTION IN AN OPTICAL TRANSPORT SYSTEM

(75) Inventor: Peter J. Winzer, Aberdeen, NJ (US)

(73) Assignee: ALCATEL-LUCENT USA INC., Murray Hill, NJ (US)

(21) Appl. No.: 13/018,511

(22) Filed: Feb. 1, 2011

(51) Int. Cl. H04B 10/00; H04B 10/13; H04B 10/12; H04B 10/135

(52) U.S. Cl. 398/143; 398/154; 398/144; 398/142; 398/141

(57) ABSTRACT

An optical transport system has an optical transmitter and an optical receiver coupled to one another via an optical link having a plurality of transmission paths. The optical transmitter uses at least one of the transmission paths to transmit an optical-reference signal that enables the optical receiver to obtain (i) an optical local-oscillator signal that is phase- and frequency-locked to an optical-carrier frequency used by the transmitter for the generation of data-bearing optical signals and (ii) a clock signal that is phase- and frequency-locked to the clock signal used by the transmitter. The optical receiver then uses these signals to demodulate and decode the data-bearing optical signals in a manner that significantly reduces the complexity of digital signal processing compared to that in a comparably performing prior-art system. In various embodiments, a transmission path for the optical-reference signal can be established using any suitable dimension orthogonal to those occupied by the data-bearing signals, such as polarization, wavelength, or space.

### BACKGROUND

1. Field of the Invention

The present invention relates to optical communication equipment and, more specifically but not exclusively, to reference-signal distribution in optical transport systems.

2. Description of the Related Art

This section introduces aspects that may help facilitate a better understanding of the invention(s). Accordingly, the statements of this section are to be read in this light and are not to be understood as admissions about what is in the prior art or what is not in the prior art.

To decode a polarization-division-multiplexed (PDM) higher-order quadrature amplitude modulation (QAM) signal, a coherent intradyne receiver performs a significant amount of complicated digital signal processing, which usually requires a relatively complex, expensive, and/or power-hungry ASIC. For example, some of the functions performed by a state-of-the-art ASIC that may be employed for this purpose include clock recovery, frequency recovery and tracking, phase recovery and tracking, differential decoding, polarization tracking, polarization separation, polarization-mode-dispersion (PMD) compensation, chromatic-dispersion (CD) compensation, fiber-nonlinearity compensation, etc. Disadvantageously, the high cost and power consumption associated with such an ASIC may delay or even prevent coherent intradyne receivers from entering certain cost- and/or power-sensitive applications, such as local-area network (LAN) and interface technologies, rack-to-rack interconnects, and chip-to-chip interconnects.

### SUMMARY

Disclosed herein are various embodiments of an optical transport system having an optical transmitter and an optical receiver coupled to one another via an optical link having a plurality of transmission paths. The optical transmitter uses at least one of the transmission paths to transmit an optical-reference signal that enables the optical receiver to obtain (i) an optical local-oscillator signal that is phase- and frequency-locked to an optical-carrier frequency used by the transmitter for the generation of data-bearing optical signals and (ii) a clock signal that is phase- and frequency-locked to the clock signal used by the transmitter. The optical receiver then uses these signals to demodulate and decode the data-bearing optical signals in a manner that significantly reduces the complexity of digital signal processing compared to that in a comparably performing prior-art system. In various embodiments, a transmission path for the optical-reference signal can be established using any suitable dimension orthogonal to those occupied by the data-bearing signals, such as polarization, wavelength, or space.

According to one embodiment, provided is an optical transport system comprising an optical link having a plurality of transmission paths and an optical transmitter coupled to first and second transmission paths of the optical link. The optical transmitter applies a first modulated optical signal to the first transmission path, said first modulated optical signal generated by the optical transmitter by modulating an optical carrier having a first frequency and provided by a laser source, with data of a first data stream. The optical transmitter also applies an optical-reference signal to the second transmission path, said optical-reference signal generated by the optical transmitter using light provided by the laser source. The optical transport system further comprises an optical receiver coupled to the first and second transmission paths to receive light corresponding to the first modulated optical signal from the first transmission path and light corresponding to the optical-reference signal from the second transmission path. The optical transmitter operates based on a first clock signal. The optical receiver processes the light corresponding to the optical-reference signal to generate at least one of (i) an optical local-oscillator signal having the first frequency and (ii) a second clock signal that is phase-locked to the first clock signal. The optical receiver further processes the light corresponding to the first modulated optical signal using the at least one of the optical local-oscillator signal and the second clock signal to recover the data of the first data stream.

According to another embodiment, provided is an optical transmitter coupled to an optical link having a plurality of transmission paths. The optical transmitter comprises a first optical modulator coupled to a first transmission path of the optical link to apply to said first transmission path a first modulated optical signal that the first optical modulator generates by modulating an optical carrier having a first frequency and received from a laser source, with data of a first data stream. The optical transmitter further comprises a reference-signal generator coupled to a second transmission path of the optical link to apply to said second transmission path an optical-reference signal that the reference-signal generator generates using light received from the laser source. The optical transmitter operates based on a first clock signal. The optical reference signal enables a corresponding optical receiver to derive from light corresponding to the optical reference signal at least one of (i) an optical local-oscillator signal having the first frequency and (ii) a second clock signal that is phase-locked to the first clock signal. The optical reference signal further enables the corresponding optical receiver to process light corresponding to the first modulated optical signal using the at least one of the optical local-oscillator signal and the second clock signal to recover the data of the first data stream.

According to yet another embodiment, provided is an optical receiver coupled to an optical link having a plurality of transmission paths. The optical receiver comprises a first receiver module coupled to a first transmission path of the optical link to receive therefrom light corresponding to a first modulated optical signal. The optical receiver further comprises a reference-recovery module coupled to a second transmission path of the optical link to receive therefrom light corresponding to an optical-reference signal. The first modulated optical signal and the optical-reference signal have been generated by a corresponding optical transmitter using an optical carrier having a first frequency, with the optical transmitter operating based on a first clock signal. The reference-recovery module processes the light corresponding to the optical-reference signal to produce at least one of (i) an optical local-oscillator signal having the first frequency and (ii) a second clock signal that is phase-locked to the first clock signal. The first receiver module processes the light corresponding to the first modulated optical signal using the at least one of the optical local-oscillator signal and the second clock signal to generate one or more digital signals that enable the optical receiver to recover data carried by the first modulated optical signal.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of an optical transport system according to one embodiment of the invention;

FIGS. 2A-2D show cross-sectional views of optical waveguides and waveguide arrangements that can be used to implement the optical link in the system of FIG. 1 according to various embodiments of the invention;

FIGS. 3A-3B illustrate a reference-signal generator that can be used in the system of FIG. 1 according to one embodiment of the invention;

FIGS. 4A-4D illustrate a reference-recovery module that can be used in the system of FIG. 1 according to one embodiment of the invention; and

FIGS. 5A-5H illustrate a receiver module that can be used in the system of FIG. 1 according to one embodiment of the invention.

### DETAILED DESCRIPTION

Embodiments of the present invention are directed at reducing the complexity of digital signal processing performed at a coherent receiver of an optical transport system through the use of one or more optical-reference signals that are made available to the receiver via a separate transmission path running in parallel to the transmission paths occupied by payload-data-bearing signals or being spatially multiplexed with the transmission paths that carry payload-data-bearing signals. In various embodiments, a transmission path for an optical-reference signal can be established using any physical dimension orthogonal to that (those) of the payload-data-bearing signal(s), such as time, polarization, wavelength, and/or space. Transmission of suitable optical-reference signals via a separate transmission path becomes increasingly more beneficial with the increase in the number of transmitted optical signals, for example, because such separate transmission enables a significant reduction in the complexity of one or more functional blocks that implement at least some of the receiver functions mentioned in the background section. Various embodiments of the invention can advantageously be used in a variety of applications, such as long-haul optical-transmission systems, local-area networks (LANs), and optical rack-to-rack and chip-to-chip interconnects.

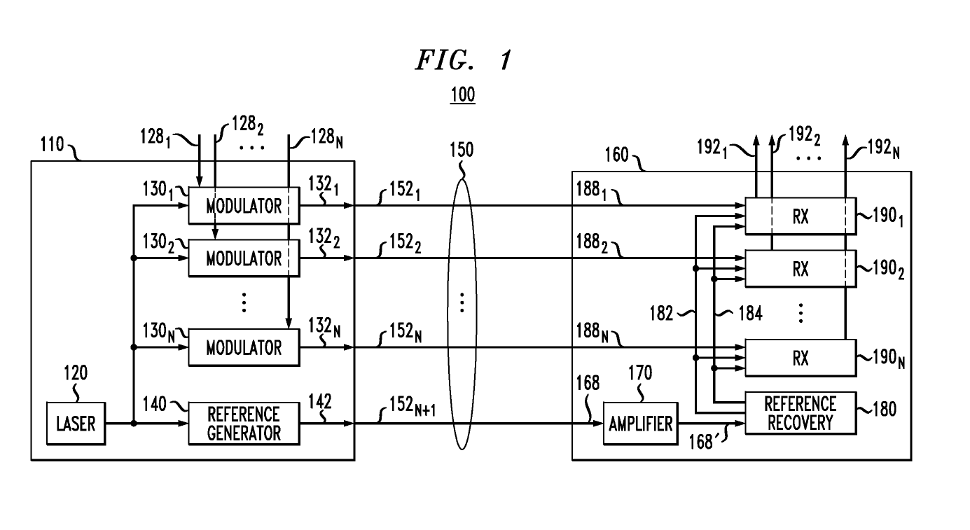

FIG. 1 shows a block diagram of an optical transport system 100 according to one embodiment of the invention. System 100 has an optical transmitter 110 and an optical receiver 160 coupled to one another via a spatially multiplexed optical link 150. Optical link 150 is illustratively shown as having N+1 transmission paths 152, where N is a positive integer. Transmission paths 152₁-152_{N} are used to transmit payload-data-bearing signals, and transmission path 152_{N+1} is used to transmit an optical-reference signal. In an alternative embodiment, optical link 150 may have different allocation of its transmission paths between payload-data-bearing signals and reference signals. For example, N−1 of transmission paths 152₁-152_{N+1} can be used to transmit payload-data-bearing signals, and the two other transmission paths can be used to transmit optical-reference signals. In various embodiments, an individual path 152 may carry a single-wavelength signal or a wavelength-division-multiplexed (WDM) signal.

In various embodiments, transmission paths 152₁-152_{N+1} may or may not be optically isolated from each other. As used herein, the term “optically isolated” means that the amount of optical crosstalk between two transmission paths 152 in question is negligibly small for the practical purposes of system 100, which means that substantially no light from one transmission path 152 couples into another transmission paths 152 along the length of optical link 150. By the same token, if two transmission paths 152 are not optically isolated from each other, a significant amount of light can couple from one transmission path 152 into another transmission path 152. Also envisioned are various configurations of optical link 150, in which different transmission paths 152 form two or more sets, each having one or more transmission paths, wherein a path belonging to one set is optically isolated from any path belonging to a different set, but not from other paths (if any) belonging to the same set. Each transmission path 152 may accommodate more than one dimension of an optical signal, e.g., two or more of time, polarization, wavelength, and space.

Transmitter 110 has a laser source 120 that generates one or more carrier wavelengths (frequencies). In one embodiment, laser source 120 has the capacity to dither the generated carrier wavelength(s) in a manner that reduces the detrimental effects of Brillouin scattering in optical link 150. The dithered light is then used in transmitter 100 for the generation of both payload-data-bearing signals and optical-reference signals.

Transmitter 110 further has N optical modulators 130₁-130_{N}, each coupled to a corresponding one of transmission paths 152₁-152_{N}. Each optical modulator 130 receives a corresponding one of input data streams 128₁-128_{N}, which it uses to produce a corresponding one of modulated optical signals 132₁-132_{N} by modulating the carrier wavelength(s) received from laser source 120. As already indicated above, each modulated optical signal 132 can be a single-wavelength signal or a WDM signal. Each modulated optical signal 132 is applied to the corresponding transmission path 152 for transmission to optical receiver 160. The data provided by data stream 128ᵢ to optical modulator 130ᵢ are the payload data carried by modulated optical signal 132ᵢ (where 1≦i≦N). In various embodiments, different optical modulators 130 may receive the same carrier wavelength or different carrier wavelengths from laser source 120.

Transmitter 110 also has a reference-signal generator 140, which is coupled to transmission path 152_{N+1}. Reference-signal generator 140 generates an optical-reference signal 142 using one or more of the carrier wavelengths generated by laser source 120. Optical-reference signal 142 is applied to transmission path 152_{N+1} for transmission to optical receiver 160, where it is used, as further described below, to demodulate optical signals 188₁-188_{N} corresponding to modulated optical signals 132₁-132_{N}. Note that optical-reference signal 142 does not carry any payload data. The use of optical-reference signal 142 enables optical receiver 160 to reduce the complexity of digital signal processing associated with the demodulation of signals 188₁-188_{N} compared to that of a comparably performing prior-art receiver. Due to this complexity reduction, optical receiver 160 can advantageously be implemented using a less complex, less expensive, and/or less power-consuming ASIC than those used in prior-art receivers.

Optical receiver 160 has an optional optical amplifier or injection-locked laser 170 that amplifies an optical signal 168 received from transmission path 152_{N+1} to produce an amplified signal 168′. Depending on the particular embodiment of optical link 150, optical signal 168 may have one or more components. For example, optical signal 168 usually has a signal component that corresponds to optical-reference signal 142. This signal component typically is an attenuated version of optical-reference signal 142, which may have also been subjected to some transmission-path impairments, such as dispersion and fiber nonlinearity, in transmission path 152_{N+1}. If transmission path 152_{N+1} is not optically isolated from transmission paths 152₁-152_{N}, then optical signal 168 may also have one or more additional signal components corresponding to modulated optical signals 132₁-132_{N}.

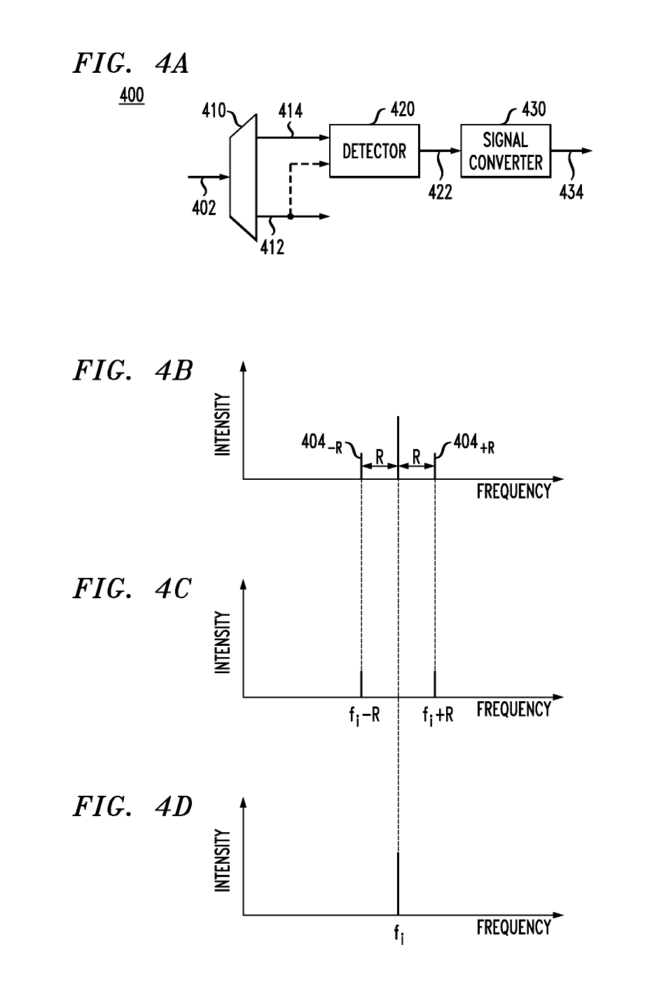

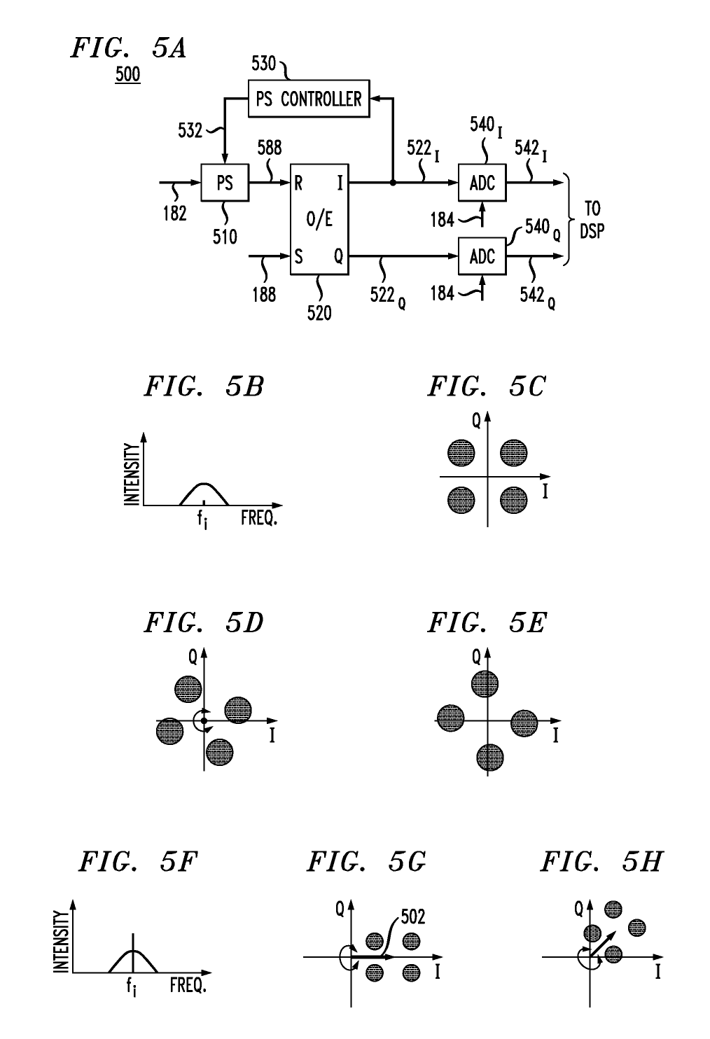

Amplified signal 168′ or, in the absence of amplifier 170, signal 168 is applied to a reference-recovery (RR) module 180. RR module 180 processes optical signal 168′ (or 168), e.g., as further described below in reference to FIGS. 4-5, to produce an optical local-oscillator (OLO) signal 182 and/or an electrical reference signal 184. Copies of signals 182 and 184 are provided to each of receiver modules (RXs) 190₁-190_{N}. Each receiver module 190 also receives, via the corresponding one of transmission paths 152₁-152_{N}, a respective one of optical signals 188₁-188_{N}, wherein optical signal 188ᵢ has at least a component corresponding to modulated optical signal 132ᵢ. Using one or both of signals 182 and 184, receiver module 190ᵢ demodulates and decodes optical signal 188ᵢ to generate an output data stream 192ᵢ. In the absence of decoding errors, output data stream 192ᵢ carries the same data as input data stream 128ᵢ.

In various embodiments, optical signal 182 and electrical signal 184 may be used for one or more of clock recovery, frequency recovery and tracking, phase recovery and tracking, polarization tracking, and polarization separation.

For example, since signal 182 has the exact same carrier wavelength(s) as that (those) used by optical modulators 130₁-130_{N} for the generation of modulated optical signals 132₁-132_{N}, the use of signal 182 as an OLO signal for coherent detection of optical signals 188₁-188_{N} in receiver modules 190₁-190_{N} automatically provides frequency recovery and tracking, which can therefore be removed from the digital-domain processing. For optical link 150 having a relatively short length, optical-path differences between different optical paths 152 are typically smaller than the coherence length of laser source 120, which automatically causes signal 182 and signal 188 to be phase-locked to each other. For optical link 150 having a relatively large length, special attention may be needed to implement the link so that optical-path differences between different optical paths 152 are smaller than the coherence length of laser source 120. These optical-link characteristics help to ensure that signal 182 and signal 188 are automatically phase-locked to one another over relatively long time periods corresponding to thermal and/or mechanical perturbations in the link. The automatic phase lock is beneficial, for example, because it helps to substantially eliminate cycle slips and, hence, removes the need for differential data encoding/decoding, which can be used to further simplify the data processing and improve performance.

Optical signal 182 can further be used for polarization control. For example, when system 100 is used to transmit PDM signals, transmitter 110 may be configured to add a relatively weak, unmodulated pilot carrier to only one of the two transmitted polarizations. Then, receiver 160 may be configured to mix a PDM signal 188 with signal 182 and use a polarization controller (not explicitly shown in FIG. 1) at the corresponding input port to rotate the polarization of PDM signal 188 so as to maximize the amplitude of the beating between the pilot carrier of signal 188 and OLO signal 182 to appropriately align the polarization components of signal 188 with the principal polarization axes of the polarization-separating optics in the corresponding receiver module 190. As a result, the need for relatively complicated polarization-separation algorithms in the digital domain is alleviated, thereby simplifying the digital signal processing performed at receiver 160.

Electrical reference signal 184 can be used as a clock signal that is phase- and frequency-locked to the clock signal used at transmitter 110. As such, signal 184 can aid or be used to replace other means for recovering the clock signal at receiver 160. The use of signal 184 instead of prior-art clock recovery may particularly be beneficial when system 100 operates in a data-burst mode, wherein relatively short periods (bursts) of data transmission are separated by relatively protracted idle (no-transmission) periods or when packets originating from different transmitters (and hence with slightly different clock rates) are sequentially transmitted over the same optical path. Disadvantageously for both of these scenarios of burst-mode transmission, conventional clock-recovery methods may break down because they typically require a certain minimum transmission time to be able to accurately recover the clock signal from the payload-data-bearing signals or from a dedicated packet header before data decoding may take place. In contrast, signal 184 is not subject to such a requirement since it carries the correct clock information that is essentially synchronous with the packet's data payload and can advantageously be generated, with the correct frequency and phase, substantially instantaneously at the onset of a transmission burst. A signal analogous to signal 184 can similarly be used in direct-detection receivers (not only in coherent receivers).

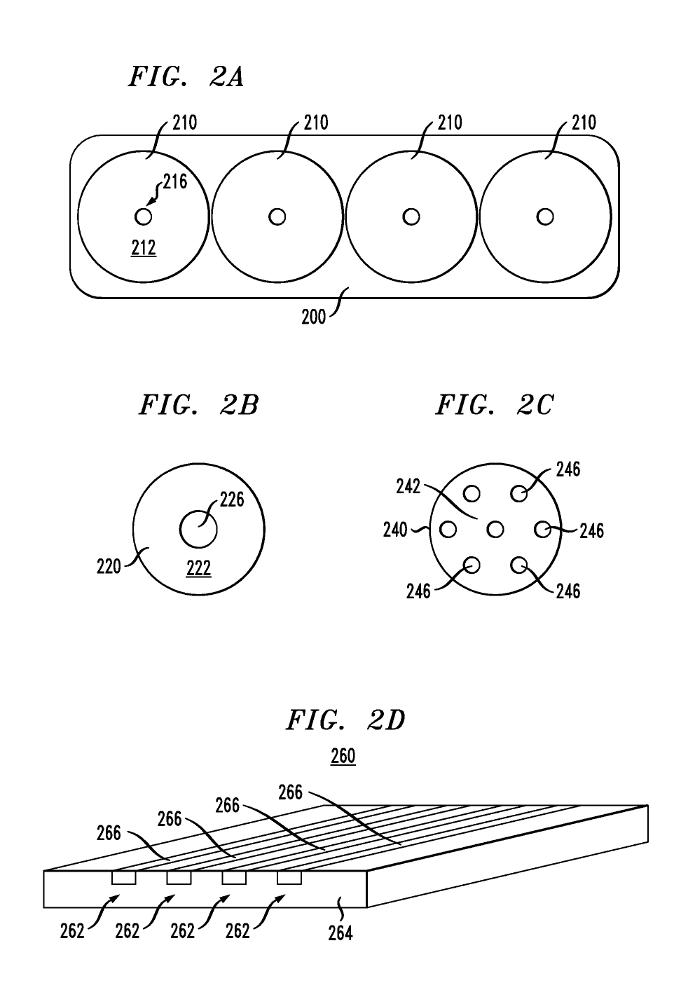

FIGS. 2A-2D show (not to scale) cross-sectional views of optical waveguides and waveguide arrangements that can be used to implement optical link 150 (FIG. 1) according to various embodiments of the invention.

FIG. 2A shows a cross-sectional view of a fiber ribbon 200 having four single-mode fibers 210. Fiber 210 has a cladding 212 and a core 216. Core 216 has a relatively small diameter, which causes fiber 210 to support a single guided mode for any wavelength from the range of wavelengths employed in system 100. In one embodiment, optical link 150 can be implemented using N+1 fibers 210, with each of said fibers serving as a corresponding one of transmission paths 152₁-152_{N+1} (see FIG. 1). In various embodiments, the N+1 fibers 210 can be spatially arranged to form a fiber ribbon that is similar to fiber ribbon 200 of FIG. 2A, a fiber cable having a sheath that encloses multiple fiber strands, or a relatively loose bundle of separate, individual fibers.

FIG. 2B shows a cross-sectional view of a multimode fiber 220. Fiber 220 has a cladding 222 and a core 226. Fiber 220 differs from fiber 210 in that core 226 has a larger diameter than core 216. In various embodiments, the diameter of core 226 is chosen to enable fiber 220 to support a desired number of guided modes selected from a range between two and about one hundred. In one embodiment, optical link 150 can be implemented using a single fiber 220, with different guided modes of the fiber serving as different transmission paths 152₁-152_{N+1}. In an alternative embodiment, optical link 150 can be implemented using N+1 fibers 220, with each of said fibers serving as a corresponding one of transmission paths 152₁-152_{N+1}.

FIG. 2C shows a cross-sectional view of a multi-core fiber 240. Fiber 240 has a cladding 242 and a plurality of cores 246 enclosed within the cladding. The diameter of each core 246 can be chosen to cause the core to support either a single guided mode or multiple guided modes. In one embodiment, optical link 150 can be implemented using fiber 240 having N+1 cores 246, with each of said cores or each of guided modes propagating in each of said cores serving as a corresponding one of transmission paths 152₁-152_{N+1}. In one embodiment, cores 246 can be used to implement a set of non-optically-isolated transmission paths 152, with different cores representing different transmission paths of the set.

FIG. 2D shows a three-dimensional view of a planar integrated lightwave circuit (PIC) 260 having four optical waveguides 262. PIC 260 has a substrate 264 that serves as a cladding for each of optical waveguides 262. Each waveguide 262 also has a corresponding core 266 that has a higher index of refraction than substrate 264. In one embodiment, optical link 150 can be implemented using a PIC that is similar to PIC 260 but having N+1 optical waveguides 262, with each of said optical waveguides serving as a corresponding one of transmission paths 152₁-152_{N+1} (see FIG. 1). In various embodiments, optical waveguides 262 may or may not be optically isolated from one another.

One skilled in the art will understand that, in addition to the fibers shown in FIGS. 2A-D, optical link 150 (FIG. 1) can employ other types of fiber. For example, a multi-core waveguide having cores of two or more different sizes that are made of two or more different materials can be fabricated to implement the waveguide features indicated above in reference to FIGS. 2C and 2D.

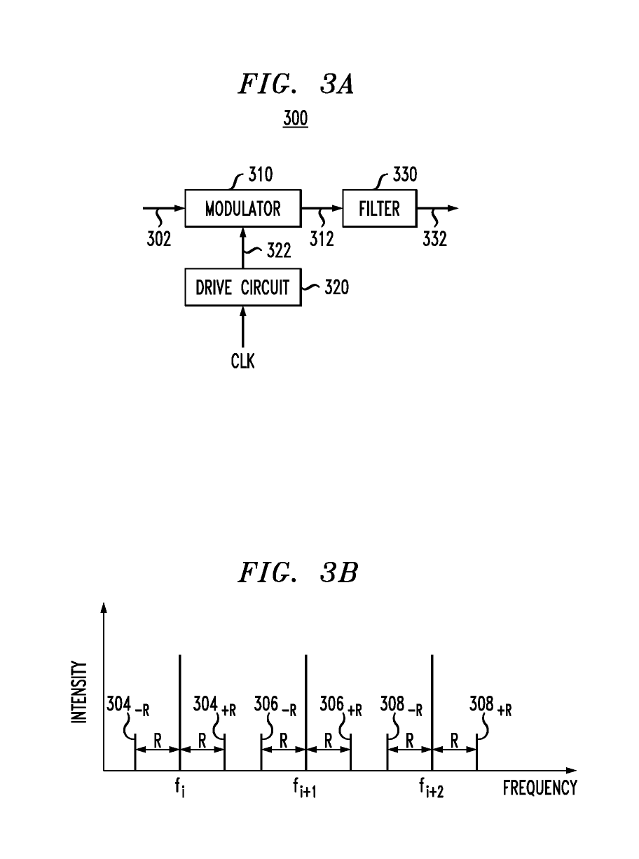

FIGS. 3A-3B illustrate a reference-signal generator 300 that can be used as reference-signal generator 140 (FIG. 1) according to one embodiment of the invention. More specifically, FIG. 3A shows a block diagram of reference-signal generator 300. FIG. 3B graphically shows spectral characteristics of certain optical signals in reference-signal generator 300.

Referring to FIG. 3A, generator 300 receives an optical input signal 302, e.g., from laser source 120 (FIG. 1). Generator 300 also receives an electrical clock signal, CLK, that can be, e.g., an internal clock signal of transmitter 110. In one embodiment, clock signal CLK is synchronous with input data streams 128₁-128_{N} and is used to synchronize optical modulators 130₁-130_{N} with one another. In a representative embodiment, clock signal CLK is provided in the form of a rectangular wave, e.g., having a 50% duty cycle. Generator 300 uses optical signal 302 and clock signal CLK to generate an optical output signal 332, e.g., as further described below. Signal 332 can be used in transmitter 110 as optical-reference signal 142 (FIG. 1). In an alternative embodiment, clock signal CLK may be provided in the form of a sinusoidal wave.

Generator 300 has a drive circuit 320 coupled to an optical modulator 310 as indicated in FIG. 3A. Drive circuit 320 receives clock signal CLK and converts it into an electrical drive signal 322 by performing one or more of the following operations: (i) reducing the signal frequency by a factor of K, where K is an integer, a real number, or a rational number greater than one; (ii) optionally converting a rectangular wave into a sinusoidal wave or other suitable periodic waveform; (iii) amplifying the periodic waveform; and (iv) adding an appropriate dc bias to the periodic waveform. If clock signal CLK has frequency f_{CLK}, then electrical drive signal 322 has frequency R=f_{CLK}/K . Electrical drive signal 322 is used to drive optical modulator 310.

In one embodiment, optical modulator 310 is an intensity modulator. When optical input signal 302 has a plurality of carrier frequencies (wavelengths), such as carrier frequencies fᵢ, fᵢ₊₁, and fᵢ₊₂ shown in FIG. 3B, an optical signal 312 generated by the intensity modulator 310 based on signals 302 and 322 contains two sidebands per carrier frequency, each of which sidebands is offset from the carrier frequency by frequency R. For example, for carrier frequency fᵢ, signal 312 has sidebands 304_{-R} and 304_{+R}; for carrier frequency fᵢ₊₁, signal 312 has sidebands 306_{-R} and 306_{+R}; and, for carrier frequency fᵢ₊₂, signal 312 has sidebands 308_{-R} and 308_{+R} (see FIG. 3B). As indicated in FIG. 3B, the value of K for drive circuit 320 is selected so that 2R is smaller than the spacing between two adjacent carrier frequencies, e.g., the spacing between fᵢ and fᵢ₊₁.

In another embodiment, optical modulator 310 is a Mach-Zehnder modulator. When optical input signal 302 has a single carrier frequency, e.g., carrier frequency fᵢ (FIG. 3B), and electrical drive signal 322 has a dc component that configures the Mach-Zehnder modulator 310 to operate at a transmission null, optical signal 312 generated by the Mach-Zehnder modulator contains two sidebands corresponding to the carrier frequency, but the carrier frequency itself is suppressed in the modulator. For example, if carrier frequency fᵢ is applied to the Mach-Zehnder modulator 310, then signal 312 has sidebands 304_{-R} and 304_{+R}, but no carrier frequency fᵢ. This spectrum can be visualized in FIG. 3B by removing from the graph all carrier frequencies and all sidebands, except sidebands 304_{-R} and 304_{+R}.

Optical signal 312 produced by optical modulator 310 is applied to an optional optical filter 330, and a filtered optical signal produced by filter 330 is optical output signal 332. In one embodiment, filter 330 is designed to transmit two selected frequency components of optical signal 312, one of which is a sideband, while blocking all other frequency components. For example, if optical signal 312 has the spectral composition indicated in FIG. 3B, then filter 330 may be designed to transmit only carrier frequency fᵢ and sideband 304_{-R}, while blocking carrier frequencies fᵢ₊₁ and fᵢ₊₂ and sidebands 304_{+R}, 306_{-R}, 306_{+R}, 308_{-R}, and 308_{+R}. In another embodiment, filter 330 is designed to transmit three selected frequency components of optical signal 312, e.g., carrier frequency fᵢ and sidebands 304_{-R} and 304_{+R}, while blocking carrier frequencies fᵢ₊₁ and fᵢ₊₂ and sidebands 306_{-R}, 306_{+R}, 308_{-R}, and 308_{+R}. In yet another embodiment, filter 330 is designed to transmit only sidebands 304_{-R} and 304_{+R}, while blocking carrier frequencies fᵢ, fᵢ₊₁, and fᵢ₊₂ and sidebands 306_{-R}, 306_{+R}, 308_{-R}, and 308_{+R}. Optical filter 330 may be removed from generator 300 when signal 312 already has a desired spectral composition, e.g., only sidebands 304_{-R} and 304_{+R} and no carrier frequency fᵢ, as in the above-described embodiment employing the appropriately biased Mach-Zehnder modulator 310.

FIGS. 4A-4D illustrate a reference-recovery (RR) module 400 that can be used as RR module 180 (FIG. 1) according to one embodiment of the invention. More specifically, FIG. 4A shows a block diagram of RR module 400. FIGS. 4B-4D graphically show spectral characteristics of certain optical signals in RR module 400.

Referring to FIG. 4A, RR module 400 receives an optical input signal 402, which can be signal 168 or 168′ coming from transmission path 152_{N+1} (FIG. 1). RR module 400 uses optical input signal 402 to produce one or more optical output signals 412 and/or one or more electrical output signals 434. More than one signal 412 and more than one signal 434 may be generated, e.g., when signal 402 is a WDM signal. Additional signals 434 may be generated to support additional functions, such as clock recovery and extraction of packet sync information. Signals 412 and 434 can be used in receiver 160 as OLO signal 182 and electrical reference signal 184, respectively (see FIG. 1).

Optical input signal 402 is applied to a de-multiplexer 410 that de-multiplexes it into optical signals 412 and 414. FIGS. 4B-4D graphically illustrate how signals 402, 412, and 414 may be related to one another in one embodiment of RR module 400. More specifically, FIG. 4B shows the spectral composition of signal 402, which has carrier frequency fᵢ and sidebands 404_{-R} and 404_{+R} (also see FIG. 3B). FIG. 4C shows the spectral composition of signal 414, which has sidebands 404_{-R} and 404_{+R} but no carrier frequency fᵢ. FIG. 4D shows the spectral composition of signal 412, which has carrier frequency fᵢ but no sidebands 404_{-R} and 404_{+R}.

In an alternative embodiment of RR module 400, signal 414 may have a single sideband, e.g., only sideband 404_{-R} or only sideband 404_{+R}.

In one embodiment, an optical detector 420 is a conventional square-law detector that converts the optical signal(s) applied thereto into an electrical signal 422. Depending on the spectral composition of signal 414, optical detector 420 may be configured to receive only signal 414 or both signal 414 and signal 412 (as indicated by the dashed line in FIG. 4A). More specifically, when signal 414 has both sidebands 404_{-R} and 404_{+R}, as shown in FIG. 4C, optical detector 420 is configured to receive only signal 414. Alternatively, when signal 414 has only one of sidebands 404_{-R}/404_{+R}, optical detector 420 is configured to receive both signals 412 and 414. In certain embodiments, de-multiplexer 410 may be omitted or bypassed so that signal 402 is applied directly to optical detector 420.

Electrical signal 422 usually has a dc component and a sinusoidal ac component. When optical detector 420 receives light having two different optical frequency components whose spacing falls within the bandwidth of detector 420, electrical signal 422 has an ac component having a corresponding difference frequency. For example, when optical detector 420 receives signal 414 having both sidebands 404_{-R} and 404_{+R}, as shown in FIG. 4C, electrical signal 422 has a sinusoidal ac component of frequency 2R, which is the difference frequency for optical frequencies (fᵢ+R) and (fᵢ−R). Similarly, when optical detector 420 receives (i) signal 414 having only one of sidebands 404_{-R} and 404_{+R} and (ii) the signal 412 shown in FIG. 4D, electrical signal 422 has a sinusoidal ac component of frequency R.

A signal converter 430 converts electrical signal 422 into a clock signal 434 that is synchronous with (e.g., phase- and frequency-locked to) clock signal CLK of FIG. 3A. More specifically, signal converter 430 converts electrical signal 422 into clock signal 434 by performing one or more of the following operations: (i) multiplying the signal frequency by a factor of K′ or K′/2, where K′ is a number that is the same as or different from K; (ii) converting a sinusoidal wave into a rectangular wave or other suitable periodic waveform; (iii) amplifying or attenuating the periodic waveform; and (iv) subtracting a dc component from the periodic waveform. One skilled in the art will appreciate that the use of clock signal 434 in receiver 160 substantially eliminates the need for digitally performing thereat clock-recovery operations based on payload-data-bearing signals 188₁-188_{N} because clock signal 434 is phase- and frequency-locked to the clock signal that has been used at transmitter 110 to generate modulated optical signals 132₁-132_{N} corresponding to signals 188₁-188_{N}.

Optical signal 412 generally contains the same carrier frequencies (wavelengths) as signal 142. For example, in one embodiment, optical signal 412 may contain a single carrier frequency, e.g., as shown in FIG. 4D. In an alternative embodiment, optical signal 412 may contain multiple carrier frequencies, e.g., carrier frequencies fᵢ, fᵢ₊₁, and fᵢ₊₂ shown in FIG. 3B. Possible uses of signal 412 have already been described above in the description of signal 182 (FIG. 1) and include, without limitation, frequency recovery and tracking, phase recovery and tracking, polarization tracking, and polarization separation.

FIGS. 5A-5H illustrate a receiver module 500 that can be used as each one of receiver modules 190 (FIG. 1) according to one embodiment of the invention. More specifically, FIG. 5A shows a block diagram of receiver module 500. FIGS. 5B-5H graphically show spectral and constellation-mapping characteristics of certain optical signals in receiver module 500. Note that receiver module 500 may be used to process a single polarization of a PDM signal.

Referring to FIG. 5A, receiver module 500 has an optical-to-electrical (O/E) converter 520 having two input ports labeled S and R and two output ports labeled I and Q. Input port R receives phase-shifted signal 588, which is produced by a phase shifter (PS) 510 after it applies a selected phase shift to OLO signal 182 (FIG. 1). Input port S receives modulated optical signal 188 (FIG. 1).

O/E converter 520 mixes signals 188 and 588 to generate four mixed optical signals (not explicitly shown in FIG. 5). O/E converter 520 then converts the four mixed optical signals into two analog electrical signals 522_{I} and 522_{Q} that are indicative of the real and imaginary parts of the complex values of signal 188 in the complex plane defined by phase-shifted OLO signal 588. More specifically, electrical signals 522_{I} and 522_{Q} are an analog in-phase signal and an analog quadrature-phase signal, respectively, corresponding to signal 188.

In one embodiment, O/E converter 520 is a 90-degree optical hybrid with two balanced photo-detectors coupled to its four output ports. Various suitable 90-degree optical hybrids are commercially available, e.g., from Optoplex Corporation of Fremont, Calif., and CeLight, Inc., of Silver Spring, Md. Additional information on various O/E converters that can be used to implement O/E converter 520 in various embodiments of receiver module 500 are disclosed, e.g., in U.S. Patent Application Publication No. 2010/0158521, U.S. patent application Ser. No. 12/541,548 (filed on Aug. 14, 2009), and International Patent Application No. PCT/US09/37746 (filed on Mar. 20, 2009), all of which are incorporated herein by reference in their entirety.

Each of electrical signals 522_{I} and 522_{Q} is converted into digital form in a corresponding one of analog-to-digital converters (ADCs) 540, which use clock signal 184 (FIG. 1) to set the sampling rate and time (phase) of the analog-to-digital conversion operations performed therein. Optionally, each of electrical signals 522_{I} and 522_{Q} may be amplified in a corresponding amplifier (not explicitly shown) prior to the resulting signal being converted into digital form. Digital signals 542_{I} and 542_{Q} produced by ADCs 540 are directed for further processing to a digital signal processor (DSP, not explicitly shown in FIG. 5A). Depending on the particular embodiment, each receiver module 500 may have an individual DSP, or different receiver modules 500 may share a single shared DSP that is a part of the corresponding receiver, e.g., receiver 160 (FIG. 1).

The phase shift applied by phase shifter 510 to OLO signal 182 is controlled by a PS controller 530 via a control signal 532. In one embodiment (shown in FIG. 5A), PS controller 530 uses signal 522_{I}as a feedback signal that enables the PS controller to determine the phase-shift value for phase shifter 510, e.g., by generating control signal 532 to maximize the peak power of signal 522_{I}. In an alternative embodiment, PS controller 530 may similarly use signal 522_{Q}, instead of signal 522_{I}, as a feedback signal for said determination. In yet another embodiment, phase shifter 510 may be (i) moved from its position in front of port R of O/E converter 520 (shown in FIG. 5A) to a position in front of port S of the O/E converter and (ii) reconfigured to apply a phase shift that has the same magnitude but an opposite sign. As an alternative modification, phase shifter 510 may be moved from receiver module 500 to RR module 180, which enables a single phase shifter 510 to be shared by and/or serve multiple receiver modules 500 (or 190). In yet another alternative embodiment, instead of doing feedback control via phase shifter 510 (as shown in FIG. 5A), signal 532 may be fed forward into the DSP for electronic (instead of optical) correction of the phase shift. The DSP would still do a “phase-rotation” operation in this case, but would not be configured to do a “phase-estimation” operation, which is much more complex and expensive in terms of the required DSP resources.

Phase shifter 510 and PS controller 530 take advantage of the inherently high frequency and phase accuracy of OLO signal 182 to implement phase recovery and tracking, which enables the corresponding receiver to eliminate (not to perform) these operations in the digital domain, thereby simplifying the digital signal processing performed by the corresponding DSP. Phase-recovery and tracking operations are useful, e.g., when transmission paths 152₁-152_{N+1} exhibit significantly different and/or randomly fluctuating optical phase delays, with the phase fluctuations still being relatively slow compared to the symbol or bit rate.

FIGS. 5B-5H graphically illustrate two representative phase-tracking schemes that can be implemented using phase shifter 510 and PS controller 530. More specifically, FIGS. 5B-5E graphically illustrate a first phase-tracking scheme, in which signal 132 (FIG. 1) corresponding to the signal 188 applied to receiver module 500 is a QAM signal that uses a 4-QAM constellation shown in FIG. 5C and has a spectrum shown in FIG. 5B. Note that the spectrum shown in FIG. 5B corresponds to carrier frequency fᵢ, but no carrier tone at the carrier-frequency position is present in the spectrum. FIGS. 5F-5H graphically illustrate a second phase-tracking scheme, in which signal 132 (FIG. 1) corresponding to the signal 188 applied to receiver module 500 is a QAM signal that uses a 4-QAM constellation shown in FIG. 5G and has a spectrum shown in FIG. 5F. Note that the spectrum shown in FIG. 5F also corresponds to carrier frequency fᵢ, but, in contrast to the spectrum of FIG. 5B, it does include a component corresponding to the unmodulated carrier frequency.

Referring to FIGS. 5B-5E, the above-mentioned randomly fluctuating optical-phase delays typically cause a relatively slow, random rotation of the apparent constellation perceived by the receiver about the origin of the corresponding complex plane, as indicated by the double-headed arrow in FIG. 5D. This rotation causes the perceived constellation to vary over time, thereby making the individual constellation symbols (points) to become undecodable in terms of the data codewords they represent. The phase shift applied by phase shifter 510 stops the rotation and locks the orientation of the perceived constellation, e.g., into that shown in FIG. 5E, thereby enabling the DSP to establish a one-to-one correspondence between the symbols (points) of the original constellation shown in FIG. 5C and the symbols (points) of the perceived constellation shown in FIG. 5E.

PS controller 530 locks the orientation of the perceived constellation by configuring phase shifter 510 to apply a phase shift that minimizes or maximizes the peak power of one of the quadratures corresponding to signal 188. For example, in the embodiment shown in FIG. 5A, PS controller 530 configures phase shifter 510 to minimize or maximize the peak power of the I (in-phase) quadrature represented by signal 522_{I}. In an alternative embodiment, PS controller 530 may similarly configure phase shifter 510 to minimize or maximize the peak power of the Q (quadrature-phase) quadrature represented by signal 522_{Q}, and may process the resulting signal by itself, jointly with, or independently of the one derived from signal 522_{I}.

Referring now to FIGS. 5C and 5F-5H, the presence of the unmodulated carrier frequency in the signal spectrum causes the center of the perceived constellation to become shifted with respect to its original position shown in FIG. 5C by a vector 502, as shown in FIG. 5G, with the length of the vector being related to the intensity of the unmodulated-carrier component shown in FIG. 5F. The randomly fluctuating optical-phase delays then cause the shifted constellation to rotate about the origin of the complex plane, as indicated by the double-headed arrows in FIGS. 5G-5F. The phase shift applied by phase shifter 510 stops the rotation and locks the orientation of the perceived constellation into the proper position. The appropriate value of the phase shift is determined by PS controller 530 based on the minimization of the average or peak power of one of the quadratures corresponding to signal 188, e.g., of the I (in-phase) quadrature represented by signal 522_{I} or the Q (quadrature-phase) quadrature represented by signal 522_{Q}.

While this invention has been described with reference to illustrative embodiments, this description is not intended to be construed in a limiting sense. For example, although certain embodiments of the invention have been described in reference to a 4-QAM constellation, other constellations, such as QAM constellations having a different number of constellation points or various PSK constellations, can also be used. Drive circuit 320 in reference generator 140 and signal converter 430 in RR module 180 can be configured to use different respective values of K.

Various modifications of the described embodiments, as well as other embodiments of the invention, which are apparent to persons skilled in the art to which the invention pertains are deemed to lie within the principle and scope of the invention as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

What is claimed is:

1. An optical transport system, comprising:
an optical link having a plurality of transmission paths;
an optical transmitter coupled to first and second transmission paths of the optical link to apply:
a first modulated optical signal to the first transmission path, said first modulated optical signal generated by the optical transmitter by modulating an optical carrier having a first frequency and provided by a laser source, with data of a first data stream; and
an optical-reference signal to the second transmission path, said optical-reference signal generated by the optical transmitter using light provided by the laser source; and
an optical receiver coupled to the first and second transmission paths to receive:
light corresponding to the first modulated optical signal from the first transmission path; and
light corresponding to the optical-reference signal from the second transmission path, wherein:
the optical transmitter is configured to operate based on a first clock signal;
the optical receiver is configured to process the light corresponding to the optical-reference signal to generate at least one of (i) an optical local-oscillator signal having the first frequency and (ii) a second clock signal that is phase-locked to the first clock signal; and
the optical receiver is further configured to process the light corresponding to the first modulated optical signal using the at least one of the optical local-oscillator signal and the second clock signal to recover the data of the first data stream.

2. The system of claim 1, wherein:
the optical reference signal carries no data; and
the optical transmitter is configured to generate the optical reference signal by modulating the optical carrier based on the first clock signal.

3. The system of claim 1, wherein the optical link comprises a plurality of single-mode waveguides, with each single-mode waveguide providing a respective transmission path of the optical link.

4. The system of claim 1, wherein the optical link comprises a multimode waveguide, with different waveguide modes of the multimode waveguide providing different respective transmission paths for the optical link.

5. The system of claim 1, wherein the optical link comprises a multi-core waveguide, with each waveguide core providing a respective transmission path of the optical link.

6. The system of claim 1, wherein the first transmission path and the second transmission path are optically isolated from one another.

7. The system of claim 1, wherein:
the optical link comprises an optical waveguide;
the first transmission path is a first polarization mode of the optical waveguide; and
the second transmission path is a second polarization mode of the optical waveguide, which is orthogonal to the first polarization mode.

8. The system of claim 1, wherein the optical receiver is configured to process the light corresponding to the first modulated optical signal using both the optical local-oscillator signal and the second clock signal.

9. An optical transmitter adapted to be coupled to an optical link having a plurality of transmission paths, the optical transmitter comprising:
a first optical modulator adapted to be coupled to a first transmission path of the optical link to apply to said first transmission path a first modulated optical signal that the first optical modulator generates by modulating an optical carrier having a first frequency and received from a laser source, with data of a first data stream; and
a reference-signal generator adapted to be coupled to a second transmission path of the optical link to apply to said second transmission path an optical-reference signal that the reference-signal generator generates using light received from the laser source, wherein:
the optical transmitter is configured to operate based on a first clock signal; and
the optical reference signal is generated by the optical transmitter to enable a corresponding optical receiver to:
derive from light corresponding to the optical reference signal at least one of (i) an optical local-oscillator signal having the first frequency and (ii) a second clock signal that is phase-locked to the first clock signal; and
process light corresponding to the first modulated optical signal using the at least one of the optical local-oscillator signal and the second clock signal to recover the data of the first data stream.

10. The optical transmitter of claim 9, wherein the optical transmitter further comprises the laser source, which is configured to dither the first frequency.

11. The optical transmitter of claim 9, wherein the reference-signal generator comprises:
a drive circuit configured to convert the first clock signal into an electrical drive signal; and
a second optical modulator configured to receive the first optical-carrier frequency from the laser source, wherein:
the second optical modulator is configured to generate a second modulated optical signal by modulating the optical carrier while being driven by the electrical drive signal; and
the optical-reference signal is based on said second modulated optical signal.

12. The optical transmitter of claim 11, wherein the reference-signal generator further comprises an optical filter that filters the second modulated optical signal, with a resulting filtered signal being the optical-reference signal.

13. The optical transmitter of claim 11, wherein the drive circuit is configured to produce the electrical drive signal by performance of one or more of the following operations:
reducing a frequency of the first clock signal;
converting a first waveform shape into a second waveform shape;
amplifying a periodic waveform; and
adding a dc bias to a periodic waveform.

14. The optical transmitter of claim 9, further comprising one or more additional optical modulators, each adapted to be coupled to a respective different transmission path of the optical link to apply to said transmission path a respective additional modulated optical signal that the additional optical modulator generates by modulating the optical carrier received from the laser source, with data of a respective additional data stream, wherein the optical reference signal is generated by the optical transmitter to enable the optical receiver to process light corresponding to each of the additional modulated optical signals using the at least one of the optical local-oscillator signal and the second clock signal to recover the data of the respective additional data stream.

15. An optical receiver adapted to be coupled to an optical link having a plurality of transmission paths, the optical receiver comprising:
a first receiver module configured to be coupled to a first transmission path of the optical link to receive therefrom light corresponding to a first modulated optical signal that is based on an optical carrier having a first frequency; and
a reference-recovery module configured to be coupled to a second transmission path of the optical link to receive therefrom light corresponding to an optical-reference signal that is based on a first clock signal and the optical carrier having the first frequency, wherein:
the reference-recovery module is configured to process the light corresponding to the optical-reference signal to produce at least one of (i) an optical local-oscillator signal having the first frequency and (ii) a second clock signal that is phase-locked to the first clock signal; and
the first receiver module is configured to process the light corresponding to the first modulated optical signal using the at least one of the optical local-oscillator signal and the second clock signal to generate one or more digital signals that enable the optical receiver to recover data carried by the first modulated optical signal.

16. The optical receiver of claim 15, wherein the reference-recovery module comprises an optical de-multiplexer configured to separate the first frequency from the light received by reference-recovery module to generate the optical local-oscillator signal.

17. The optical receiver of claim 15, wherein the reference-recovery module comprises:
an optical detector configured to generate an electrical signal having a difference frequency corresponding to two spectral components of the optical reference signal; and
a signal converter configured to generate the second clock signal based on the difference frequency.

18. The optical receiver of claim 17, wherein the signal converter is configured to generate the second clock signal by performance of one or more of the following operations:
multiplying the difference frequency;
converting a first waveform shape into a second waveform shape;
amplifying or attenuating a periodic waveform; and
subtracting a dc component from a periodic waveform.

19. The optical receiver of claim 15, wherein the reference-recovery module comprises:
a phase shifter configured to phase-shift the optical local-oscillator signal; and
a phase-shift controller that configures the phase shifter to apply a phase shift that minimizes or maximizes a time-averaged value or a peak value of an in-phase component or a quadrature-phase component corresponding to the first modulated optical signal.

20. The optical receiver of claim 15, further comprising one or more additional optical receiver modules, each configured to be coupled to a respective different transmission path of the optical link to receive therefrom light corresponding to a respective additional modulated optical signal, wherein each additional receiver module is configured to process the light corresponding to the respective additional modulated optical signal using the at least one of the optical local-oscillator signal and the second clock signal to generate one or more additional digital signals that enable the optical receiver to recover data carried by the respective additional modulated optical signal.
